(19) United States
(12) Patent Application Publication
(10) Pub. No.: US 2023/0121868 A1
(43) Pub. Date: Apr. 20, 2023

(54) TECHNOLOGY FOR TRANSVERSELY AND LONGITUDINALLY GUIDING CONTROLLED REVERSING OF A COMMERCIAL VEHICLE AS A FOLLOWING VEHICLE IN ACCORDANCE WITH A LEADING VEHICLE

(71) Applicant: MAN Truck & Bus SE, München (DE)

(72) Inventors: Fabian Kuttenreich, MÜNCHEN (DE); Torsten KLEIN, Wolfsburg (DE); Andreas ZIMMERMANN, MÜNCHEN (DE)

(21) Appl. No.: 17/802,940

(22) PCT Filed: Feb. 16, 2021
(86) PCT No.: PCT/EP2021/051922

§ 371 Date: Aug. 26, 2022

(30) Foreign Application Priority Data
Feb. 26, 2020 (DE) 10 2020 001 267.1

(51) Int. Cl. B60W 30/165; B60W 30/06; B60W 30/18

(52) U.S. Cl. CPC B60W 30/165; B60W 30/06; B60W 30/18036; B60W 2554/802; B60W 2556/40; B60W 2710/207; B60W 2720/106

(57) ABSTRACT

The invention relates to a technology for transversely and longitudinally guiding reversing of a commercial vehicle (100)during controlled parking and/or manoeuvring of the commercial vehicle (100) as a following vehicle in accordance with a leading vehicle (200) in the surroundings of the commercial vehicle (100). The commercial vehicle (100) comprises at least one sensor (102)and/or at least one data interface (104) for sensing data of the surroundings of the commercial vehicle (100), the sensed surroundings containing the commercial vehicle (100) and/or the leading vehicle (200). Alternatively or in addition, the commercial vehicle(100)comprises at least one data interface (104)for sensing a control instruction for transverse and longitudinal guidance from the leading vehicle (200)in the surroundings of the commercial vehicle (100). The commercial vehicle (100) also comprises a control unit (108)which is designed to control the transverse and longitudinal guidance of the reversing of the commercial vehicle (100) during controlled parking and/or manoeuvring of the commercial vehicle (100) depending on the sensed data ofthe surroundings and/or the sensed control instruction.

The present present disclosure relates to technology for transversely and longitudinally guiding reversing of a commercial vehicle during controlled parking and/or maneuvering of the commercial vehicle as a following vehicle in accordance with a leading vehicle in an environment of the commercial vehicle. In particular, a commercial vehicle as a following vehicle, an apparatus which is installed or can be installed in a leading vehicle and a system comprising the commercial vehicle and a leading vehicle having the apparatus are provided.

The patent specification DE 10 2010 012 402 B4 discloses an improvement in the driving comfort by means of vehicle-to-vehicle transmission of sensor data relating to potentially dangerous road conditions such as weather-related conditions or unevennesses of the road surface or traffic jams.

According to the “Studie Mobilität 2025: Koexistenz oder Konvergenz von IKT für Automotive? Anforderungen der vernetzten Mobilität von morgen an Fahrzeuge, Verkehrs-und Mobilfunkinfrastruktur″ [Mobility study 2025: Coexistence or convergence of ICT for the automotive sector? Requirements imposed on vehicles, traffic and mobile radio infrastructure by tomorrow’s networked mobility] dated January 2016 in the BMWi support program “IKT für Elektromobilität II” [ICT for electro-mobility II], communication not only with surrounding vehicles but also with the traffic infrastructure and with external cloud-based services is also included, in addition to sensor data from a vehicle, in a decision for initiating suitable measures in the vehicle.

The transverse and longitudinal guidance of a following vehicle by means of a leading vehicle driving in front is restricted, during conventional platooning (that is to say driving in a vehicle group or follow control), to operation in forward travel of both the leading vehicle driving in front and the following vehicles driving behind. The article “Fahrzeug-Verbund auf normaler Autobahn vorgestellt” [Vehicle group imagined on a normal freeway] dated Jun. 27, 2012 in the Deutsche Verkehrszeitung [specialist magazine for German transport] describes, for example, a freeway journey at a constant speed and a constant spacing in the vehicle group with a truck and an automobile.

The conventional transverse and longitudinal guidance of a following vehicle is therefore restricted to operation without a reversal of the direction of travel. Driving maneuvers which require reversing, in particular of a commercial vehicle, for example for docking the rear of a truck at a loading ramp for loading and/or unloading freight, may previously have been carried out only by means of an action in the commercial vehicle itself (for example without interacting with a leading vehicle).

In particular, the search for and the operation of parking at the intended parking position on unknown terrain require the full attention of the driver of the commercial vehicle. In heavily frequented depots, the traffic situation and objective may appear unclear to the driver and the driving time may be extended as a result of a lengthy search for the intended parking position.

The object is therefore to provide technology for transversely and longitudinally guiding a commercial vehicle, which technology assists the commercial vehicle during controlled parking and/or maneuvering, in particular without previous knowledge of the location on the part of the commercial vehicle. Alternatively or additionally, the object is to shorten the driving time of a professional driver of a commercial vehicle. Furthermore, alternatively or additionally, the object is to improve the traffic safety when maneuvering a commercial vehicle.

A first aspect provides a commercial vehicle for transversely and longitudinally guiding reversing of the commercial vehicle during controlled parking and/or maneuvering of the commercial vehicle as a following vehicle in accordance with a leading vehicle in an environment of the commercial vehicle. The commercial vehicle comprises at least one sensor and/or at least one data interface for capturing data relating to the environment of the commercial vehicle, wherein the captured environment comprises the commercial vehicle and/or the leading vehicle. Alternatively or additionally, the commercial vehicle comprises at least one data interface for capturing a control instruction for the transverse and longitudinal guidance from the leading vehicle in the environment of the commercial vehicle. The commercial vehicle also comprises a control unit which is designed to control the transverse and longitudinal guidance of the reversing of the commercial vehicle during controlled parking and/or maneuvering of the commercial vehicle on the basis of the captured data relating to the environment and/or the captured control instruction.

The transverse and longitudinal guidance, which can also be referred to as follow control, may comprise forward travel and reversing. The transverse and longitudinal guidance may preferably comprise a reversal of the direction of travel of the commercial vehicle.

The leading vehicle may also be referred to as a guide vehicle. The leading vehicle may be an automobile. The commercial vehicle may also be referred to as a following vehicle. The commercial vehicle may be a truck or a bus.

The at least one sensor may comprise a distance sensor for determining the distance between the leading vehicle and the following vehicle, for example between the front or the rear of the leading vehicle and the front of the following vehicle. Alternatively or additionally, the at least one sensor may determine a position (also: location) of the commercial vehicle in a usable area. The at least one sensor may comprise a radar sensor, a laser sensor (LIDAR), an ultrasonic sensor and/or imaging sensor. An imaging sensor may also be referred to as a camera.

On account of the distance being determined, the following vehicle can be guided by the leading vehicle, for example into a predetermined parking position, during reversing. In this case, the leading vehicle may travel forward, for example if the distance between the front of the leading vehicle and the front of the following vehicle has been determined.

Transverse and longitudinal guidance based on a predetermined distance between the leading vehicle and the commercial vehicle may also be referred to as a “virtual towbar”.

The at least one data interface may also be referred to as a transmission unit between the guide vehicle and the following vehicle. The at least one data interface may comprise transmission of sensor data. The sensor data may be captured by means of at least one sensor in the leading vehicle. Alternatively or additionally, the sensor data may be captured by means of a stationary sensor or an environment capture system comprising a stationary sensor, for example in a usable area, and may be transmitted from the stationary sensor or environment capture system to the leading vehicle via a sensor interface which can also be referred to as a further data interface. The sensor data may be transmitted from the leading vehicle to the following vehicle via the data interface.

Alternatively or additionally, the data interface may be designed to transmit stored data, in particular map data, relating to the environment of the commercial vehicle. The stored data may also be referred to as “a priori knowledge”. The stored data may comprise a map, for example a road map or a topographic map. Alternatively or additionally, the stored data may comprise current and/or planned occupancy data, obstacles, open areas and/or areas of the usable area which can be driven on. The stored data may comprise a planned use of the usable area, for example a planned parking position for the commercial vehicle. The planned parking position may comprise a position for loading and/or unloading a truck. Alternatively or additionally, the planned parking position may comprise a position for filling an energy store of a drive system of a commercial vehicle. The drive system may comprise an electrical traction energy storage system, a fuel-operated drive system and/or a hybrid drive. Alternatively or additionally, the stored data may comprise a preplanned target trajectory and alternative evasion target trajectories of the commercial vehicle. An alternative evasion target trajectory may be selectable depending on the situation, for example in the event of an obstacle. Furthermore, alternatively or additionally, the stored data may comprise actuator commands and/or control instructions for the commercial vehicle, for example to indicate, to warn other road users (for example pedestrians) by means of a horn, to switch on lights or to unlock a door at a defined location. Furthermore, alternatively or additionally, the stored data may comprise temporally coordinated manipulated variables for the commercial vehicle. The temporally coordinated manipulated variables may describe a vehicle maneuver of the commercial vehicle, for example depending on the location of the commercial vehicle.

Transmitting data relating to an environment or transmitting a control instruction from the leading vehicle to the commercial vehicle as a following vehicle makes it possible for a commercial vehicle unfamiliar with the location (for example with respect to digital map data or a navigation system based on the usable area) to be guided by a leading vehicle familiar with the location across a usable area, for example a depot, and/or to a parking position in a safe and time-efficient manner. Purposeful control to the destination can therefore be carried out, in particular in a large and/or heavily frequented usable area. Furthermore, the driver can already be released from his driving task upon reaching a private usable area. This makes it possible to ensure that legally prescribed break times are complied with in the case of a minimum stay in a usable area for loading and/or unloading freight or filling an energy store of a drive system of the commercial vehicle.

Furthermore, alternatively or additionally, the data interface may be designed to transmit data relating to the commercial vehicle from the commercial vehicle to the leading vehicle. Data relating to the commercial vehicle may comprise, for example, a current load, a planned future route, a planned schedule for future journeys and/or loading and unloading states or an energy store content for driving the commercial vehicle. Alternatively or additionally, data relating to the commercial vehicle may comprise a status message, for example the adoption of a stopping or parking position or the readiness to be loaded or unloaded.

Transmitting data relating to the commercial vehicle from the commercial vehicle to the leading vehicle means that the leading vehicle can adapt or optimize a parking position and/or a stay of the commercial vehicle in a usable area. Alternatively or additionally, the leading vehicle may coordinate an onward journey in the vehicle group between a plurality of commercial vehicles. Composing a vehicle group for the onward journey after staying in the usable area makes it possible to reduce the energy consumption of the commercial vehicles.

The control unit may be operatively connected to an actuator system of the commercial vehicle. The control unit may control the commercial vehicle on the basis of at least one controlled variable of the transverse and longitudinal guidance. The at least one controlled variable of the transverse and longitudinal guidance may comprise a steering wheel angle and/or a steering angle and/or a speed and/or an acceleration. The at least one controlled variable may be determined in the control unit on the basis of sensor data received from the at least one sensor or the at least one data interface. Alternatively or additionally, the at least one controlled variable may be determined on the basis of control instructions received from the leading vehicle via the data interface.

The control unit may control the commercial vehicle on a target trajectory and/or to a future target position. The future target position may comprise a parking position of the commercial vehicle. The parking position may also be referred to as a loading and/or unloading position. A control instruction received from the leading vehicle via the data interface may comprise a target trajectory. The target trajectory may comprise reversing and/or a reversal of the direction of travel of the commercial vehicle. Alternatively or additionally, a control instruction received from the leading vehicle may comprise a future target position. The target position may comprise an orientation of the commercial vehicle. For example, the target position may require reverse parking. The control unit may determine a target trajectory on the basis of the future target position.

The control unit may comprise a determination unit which is designed to determine a target trajectory and/or a future target position of the commercial vehicle on the basis of the captured environment and/or control instruction. The control unit may also be designed to control the transverse and longitudinal guidance of the reversing of the commercial vehicle on the basis of the determined target trajectory and/or future target position.

The determination unit may also be referred to as a planning unit. The determination of a target trajectory may also be referred to as path planning.

The determination unit may also determine the target trajectory and/or the future target position on the basis of at least one predetermined distance between the commercial vehicle and the leading vehicle.

The sensor and/or the data interface may capture at least two simultaneous distances between a front of the commercial vehicle and the leading vehicle, preferably a rear of the leading vehicle. The at least one predetermined distance may comprise at least two simultaneous distances. The transverse and longitudinal guidance of the commercial vehicle may determine a reversing curve and/or a forward travel curve of the commercial vehicle on the basis of a comparison of the at least two captured simultaneous distances and the at least two predetermined simultaneous distances.

The at least two predetermined simultaneous distances may each comprise a predetermined minimum distance. Alternatively or additionally, the at least two predetermined simultaneous distances may each comprise a maximum distance. Transverse and longitudinal guidance of the commercial vehicle on the basis of predetermined simultaneous distances may be referred to as a “virtual towbar”.

The at least two simultaneously captured distances may each comprise a distance between the outer edges (for example on the longitudinal side) of the commercial vehicle and of the leading vehicle. The mean value of the two distances between the outer edges may correspond to the length of the “virtual towbar”. The length of the “virtual towbar” may be limited to a predetermined distance range with a minimum distance and a maximum distance. The minimum distance of the length of the “virtual towbar” can be determined by a minimum distance between the outer edges of the commercial vehicle and of the leading vehicle. The “virtual towbar” means that the commercial vehicle can be controlled by the leading vehicle into a parking position in reverse cornering. Cornering, in particular a steering angle of the commercial vehicle, can be determined on the basis of the difference between the at least two simultaneously captured distances.

Alternatively or additionally, the at least two simultaneously captured and simultaneously determined distances may each comprise a distance in the longitudinal direction (for example with respect to a longitudinal axis of the commercial vehicle) and a distance in the transverse direction (for example with respect to a longitudinal axis of the commercial vehicle). The “virtual towbar” may comprise a maximum distance in the transverse direction and a minimum distance in the longitudinal direction between the commercial vehicle and the leading vehicle.

The data relating to the environment which are received via the at least one data interface may comprise data relating to the current position of the commercial vehicle and a future target position for parking the commercial vehicle. The future target position may comprise a parking position (also: end position). Alternatively or additionally, the future target position may comprise a point on a target trajectory (also: intermediate position).

The control instruction received via the at least one data interface may comprise a specification of at least one controlled variable of the transverse and longitudinal guidance by the leading vehicle. The at least one controlled variable may comprise a steering wheel angle and/or a steering angle and/or a speed and/or an acceleration.

The target trajectory and/or the at least one controlled variable may be specified by actuating an input unit in the leading vehicle, for example by the driver of the leading vehicle. For example, the steering wheel and the pedals of the leading vehicle may be decoupled from the actuator system of the leading vehicle and may be coupled, as an input unit, to the control unit of the commercial vehicle via the at least one data interface.

The commercial vehicle may receive data relating to the environment from the leading vehicle. Alternatively or additionally, the commercial vehicle may receive a control instruction in response to a criterion being met via the data interface.

A future target position, for example a parking position, may be transmitted to the commercial vehicle via the data interface and a target trajectory and/or at least one controlled variable may be determined in the commercial vehicle by the control unit in the commercial vehicle. The leading vehicle may take over the transverse and longitudinal guidance of the commercial vehicle when a criterion is met. In particular, the leading vehicle may take over the determination of the target trajectory and/or the at least one controlled variable when the criterion is met. The criterion may correspond to a dangerous situation. For example, the criterion may comprise the undershooting of a minimum distance between the commercial vehicle and an object, for example a road user or a loading ramp at a parking position, in the environment. The leading vehicle may cause, as a control instruction, a standstill of the commercial vehicle, in particular, when the criterion is met.

A second aspect provides an apparatus for transversely and longitudinally guiding reversing of a commercial vehicle in an environment of a leading vehicle during controlled parking and/or maneuvering of the commercial vehicle as a following vehicle in accordance with the leading vehicle, wherein the apparatus is installed or can be installed in the leading vehicle. The apparatus comprises at least one sensor and/or at least one sensor interface for capturing the environment of the leading vehicle, wherein the captured environment comprises the commercial vehicle and/or the leading vehicle. The apparatus also comprises a data interface which is designed to transmit sensor data from the at least one sensor and/or from the at least one sensor interface and/or a control instruction determined on the basis of the sensor data to a data interface of the commercial vehicle.

The at least one sensor may comprise a sensor for determining the position (also: location) of the commercial vehicle. The at least one sensor may comprise a radar sensor, a laser sensor (LIDAR), an ultrasonic sensor and/or an imaging sensor. An imaging sensor may also be referred to as a camera.

The sensor interface may also be referred to as a transmission unit between the environment and the guide vehicle.

The apparatus may also comprise a determination unit which is designed to determine a target trajectory and/or a future target position of the commercial vehicle on the basis of the captured environment.

The determination unit may also determine the target trajectory and/or the future target position of the commercial vehicle on the basis of at least one predetermined distance between the commercial vehicle and the leading vehicle.

The determination unit may determine at least one controlled variable of the transverse and longitudinal guidance of the commercial vehicle. The at least one controlled variable may comprise a steering wheel angle and/or a steering angle and/or a speed and/or an acceleration.

The data relating to the captured environment which are transmitted via the data interface may comprise data relating to the current position of the commercial vehicle and a future target position for parking the commercial vehicle. The future target position may comprise a parking position (also: end position). Alternatively or additionally, the future target position may comprise a point on a target trajectory (also: intermediate position).

Alternatively or additionally, the data interface may be designed to transmit stored data, in particular map data, relating to the environment of the leading vehicle. The stored data may also be referred to as “a priori knowledge”. The stored data may comprise a map, for example a road map or a topographic map. Alternatively or additionally, the stored data may comprise current and/or planned occupancy data, obstacles, open areas and/or areas of the usable area which can be driven on. The stored data may comprise a planned use of the usable area, for example a planned parking position for the commercial vehicle. The planned parking position may comprise a position for loading and/or unloading a truck. Alternatively or additionally, the planned parking position may comprise a position for filling an energy store of a drive system of a commercial vehicle. The drive system may comprise an electrical traction energy storage system, a fuel-operated drive system and/or a hybrid drive. Alternatively or additionally, the stored data may comprise a preplanned target trajectory and alternative evasion target trajectories of the commercial vehicle. An alternative evasion target trajectory may be selectable depending on the situation, for example in the event of an obstacle. Furthermore, alternatively or additionally, the stored data may comprise actuator commands and/or control instructions for the commercial vehicle, for example to indicate, to warn other road users (for example pedestrians) by means of a horn, to switch on lights or to unlock a door at a defined location. Furthermore, alternatively or additionally, the stored data may comprise temporally coordinated manipulated variables for the commercial vehicle. The temporally coordinated manipulated variables may describe a vehicle maneuver of the commercial vehicle, for example depending on the location of the commercial vehicle.

A third aspect provides a system for transversely and longitudinally guiding reversing of a commercial vehicle during controlled parking and/or maneuvering of the commercial vehicle. The system comprises a commercial vehicle according to the first aspect and a leading vehicle having an apparatus according to the second aspect.

The system may also comprise a usable area. The usable area may comprise at least one parking option for the controlled parking of the commercial vehicle, preferably at the future target position for parking the commercial vehicle.

The usable area may comprise a stationary environment capture system. The environment capture system may comprise at least one sensor for capturing the usable area and/or stored map data relating to the usable area. Furthermore, the environment capture system may comprise a sensor interface which is designed to transmit data captured by the at least one sensor and/or the (or a subset of the) stored map data relating to the usable area to the sensor interface of the leading vehicle.

The at least one sensor of the stationary environment capture system may comprise a radar sensor, a laser sensor (LIDAR), an ultrasonic sensor and/or an imaging sensor. The at least one sensor may determine a position (also: location) of the commercial vehicle in the usable area.

Alternatively or additionally, the stationary environment capture system may comprise stored map data (stored data for short). The stored data may also be referred to as “a priori knowledge”. The stored map data may comprise a map of the usable area, for example a road map or a topographic map. Alternatively or additionally, the stored data may comprise current and/or planned occupancy data, obstacles, open areas and/or areas of the usable area which can be driven on. The stored data may comprise a planned use of the usable area, for example a planned parking position for the commercial vehicle. The planned parking position may comprise a position for loading and/or unloading a truck. Alternatively or additionally, the planned parking position may comprise a position for filling an energy store of a drive system of a commercial vehicle. The drive system may comprise an electrical traction energy storage system, a fuel-operated drive system and/or a hybrid drive. Alternatively or additionally, the stored data may comprise a preplanned target trajectory and alternative evasion target trajectories of the commercial vehicle. An alternative evasion target trajectory may be selectable depending on the situation, for example in the event of an obstacle. Furthermore, alternatively or additionally, the stored data may comprise actuator commands and/or control instructions for the commercial vehicle, for example to indicate, to warn other road users (for example pedestrians) by means of a horn, to switch on lights or to unlock a door at a defined location. Furthermore, alternatively or additionally, the stored data may comprise temporally coordinated manipulated variables for the commercial vehicle. The temporally coordinated manipulated variables may describe a vehicle maneuver of the commercial vehicle, for example depending on the location of the commercial vehicle.

The sensor interface of the environment capture system may transmit data relating to the usable area and/or the position of the commercial vehicle to the sensor interface of the leading vehicle. The data may be captured by at least one sensor (sensor data for short). Alternatively or additionally, the data may be stored in advance, for example as map data relating to the usable area (map data for short) . The sensor data and the map data may be combined and preprocessed with one another.

Alternatively or additionally, the sensor interface of the environment capture system may receive data relating to the commercial vehicle from the leading vehicle. Data relating to the commercial vehicle may comprise, for example, a current position and/or an actual trajectory. Alternatively or additionally, data relating to the commercial vehicle may comprise a current load, a planned future route, a planned schedule for future journeys and/or loading and unloading states or an energy store content for driving the commercial vehicle. Furthermore, alternatively or additionally, data relating to the commercial vehicle may comprise a status message, for example the adoption of a stopping or parking position or the readiness of the commercial vehicle to be loaded or unloaded.

Further features and advantages of the present disclosure are described below with reference to the accompanying drawings, in which:

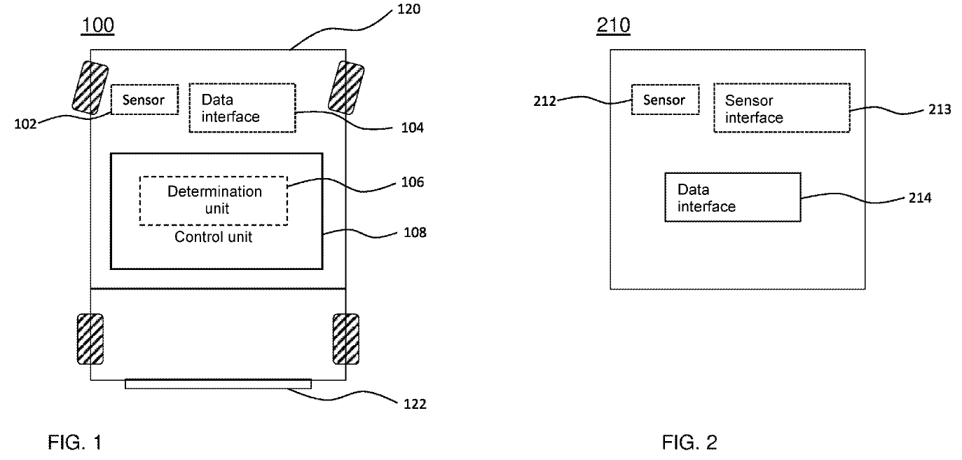

FIG. 1 shows a commercial vehicle for transversely and longitudinally guiding reversing during controlled parking and/or maneuvering as a following vehicle in accordance with a leading vehicle;

FIG. 2 shows an apparatus for transversely and longitudinally guiding reversing of a commercial vehicle according to FIG. 1, which apparatus is installed or can be installed in a leading vehicle; and

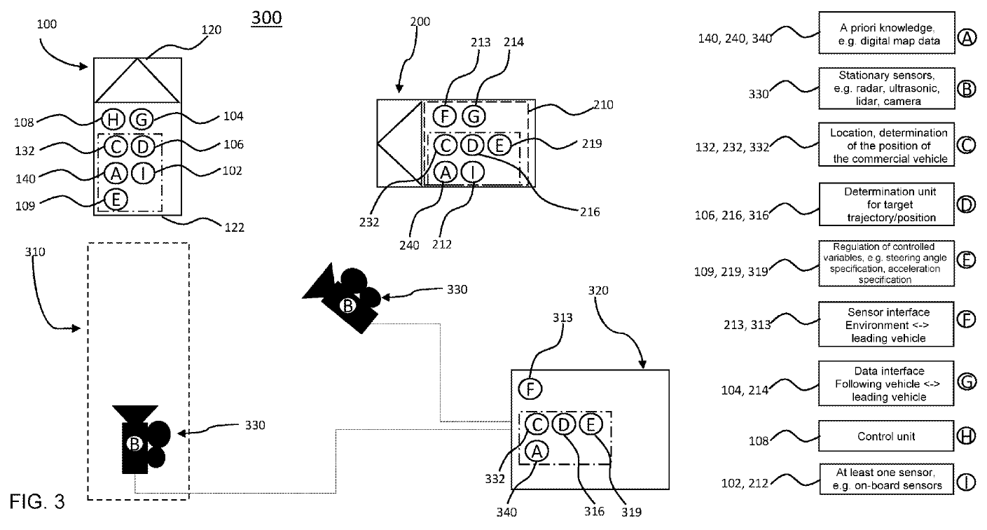

FIG. 3 shows a system for transversely and longitudinally guiding reversing of a commercial vehicle during controlled parking and/or maneuvering of the commercial vehicle, comprising a commercial vehicle according to FIG. 1 and a leading vehicle having an installed apparatus according to FIG. 2.

FIG. 1 shows a commercial vehicle, generally denoted with reference sign 100, for transversely and longitudinally guiding reversing and/or a reversal of the direction of travel of the commercial vehicle 100 during controlled parking and/or during controlled maneuvering of the commercial vehicle 100 as a following vehicle in accordance with a leading vehicle in an environment of the commercial vehicle 100. The commercial vehicle 100 comprises at least one sensor 102 and/or at least one data interface 104 for capturing data relating to the environment of the commercial vehicle 100 and/or of the leading vehicle. Alternatively or additionally, the data interface 104 may comprise a control instruction for the transverse and longitudinal guidance of the commercial vehicle 100 from the leading vehicle in the environment. Optionally, the commercial vehicle 100 may transmit data relating to the commercial vehicle 100 to the leading vehicle via the data interface 104. For example, the commercial vehicle 100 may report a load state and/or a filling level of an energy store of a drive system of the commercial vehicle 100 to the leading vehicle.

The commercial vehicle 100 also comprises a control unit 108 which is designed to control the transverse and longitudinal guidance of the reversing and/or reversal of the direction of travel of the commercial vehicle 100 during controlled parking and/or during controlled maneuvering of the commercial vehicle 100 on the basis of the captured data and/or the captured control instruction. The control unit 108 of the commercial vehicle 100 optionally comprises a determination unit 106 which is designed to determine a target trajectory and/or a future target position of the commercial vehicle 100 and to accordingly control the transverse and longitudinal guidance of the commercial vehicle 100.

In the exemplary embodiment of a commercial vehicle 100 as shown in FIG. 1, reference sign 120 is used to denote the front of the commercial vehicle 100 and reference sign 122 is used to denote the rear of the commercial vehicle 100. In the case of a truck as a commercial vehicle 100, the rear 122 may comprise rear doors and/or a tail lift (also: platform lift). Reversing of the commercial vehicle 100 as a truck may comprise the rear 122 of the commercial vehicle 100 approaching a loading ramp of a usable area.

Alternatively or additionally, a commercial vehicle 100 may comprise a bus. Reversing of a commercial vehicle 100, for example a truck or a bus, may be used to adopt a predetermined parking or stopping position. For example, the predetermined parking or stopping position, for example in a depot, may comprise positioning for the purpose of filling an energy store of a drive system of the commercial vehicle 100.

FIG. 2 shows an apparatus, generally denoted with reference sign 210, for transversely and longitudinally guiding reversing and/or a reversal of the direction of travel of a commercial vehicle in an environment of a leading vehicle during controlled parking and/or during controlled maneuvering of the commercial vehicle as a following vehicle in accordance with the leading vehicle. The apparatus 210 may be installed or installable in the leading vehicle. The apparatus 210 comprises at least one sensor 212 and/or at least one sensor interface 213 for capturing the environment of the leading vehicle. The environment of the leading vehicle may comprise the commercial vehicle and/or the leading vehicle. The at least one sensor interface 213 may be designed to receive data relating to the commercial vehicle from an external sensor, for example a stationary sensor of a stationary environment capture system. Alternatively or additionally, the at least one sensor interface 213 may be designed to transmit data relating to the commercial vehicle to an external sensor interface, for example a sensor interface of a stationary environment capture system.

The apparatus 210 also comprises a data interface 214 which is designed to transmit sensor data from the at least one sensor 212 and/or from the at least one sensor interface 213 to a data interface of the commercial vehicle, for example the data interface 104 of the commercial vehicle 100 in FIG. 1. Alternatively or additionally, the data interface 214 may be designed to transmit a control instruction to the data interface of the commercial vehicle, for example the data interface 104 of the commercial vehicle 100. The control instruction may be determined on the basis of the sensor data from the at least one sensor 212 and/or from the at least one sensor interface 213. The apparatus 210 may optionally receive data relating to the commercial vehicle via the data interface 214. For example, the commercial vehicle may transmit data relating to the environment from at least one sensor in the commercial vehicle and/or data relating to a load state and/or a filling level of an energy store of a drive system of the commercial vehicle to the apparatus 210 of the leading vehicle.

FIG. 3 shows a system, generally denoted with reference sign 300, for transversely and longitudinally guiding reversing and/or a reversal of the direction of travel of a commercial vehicle 100 during controlled parking and/or during controlled maneuvering of the commercial vehicle 100. The system comprises the commercial vehicle 100 as a following vehicle and a leading vehicle 200 having an apparatus 210. Components provided with the same reference signs as in FIG. 1 for the commercial vehicle 100 and as in FIG. 2 for the apparatus 210 may correspond to the components described with reference to FIG. 1 and FIG. 2.

The commercial vehicle 100 and the leading vehicle 200 may be designed to carry out follow control (also: platooning) known per se for transversely and longitudinally guiding the commercial vehicle 100 as a following vehicle during forward travel. Like in the known platooning, the leading vehicle 200 and the commercial vehicle 100 can communicate via the respective data interfaces 214, 104.

The system 300 illustrated in FIG. 3 also comprises a usable area 310 having a stationary environment capture system 320. The stationary environment capture system 320 may capture an environment which comprises the commercial vehicle 100 and the leading vehicle 200. The stationary environment capture system 320 may comprise at least one stationary sensor 330, for example a radar sensor, a laser sensor (LIDAR), an ultrasonic sensor or an imaging sensor (also: camera).

Map data 340 (also referred to as: “a priori knowledge”) relating to the usable area 310 may be stored by the stationary environment capture system 320. The stored map data 340 may comprise a layout and/or a current and/or future occupancy plan of loading and/or unloading points for a plurality of commercial vehicles 100.

The same map data or other data 240 may be stored (for example in a storage unit of the apparatus 210) in the leading vehicle 200 or may be transmitted from the stationary environment capture system 320 to the leading vehicle 200 via the respective sensor interfaces 313, 213. Furthermore, data relating to the environment from the at least one stationary sensor 330 may be transmitted from the sensor interface 313 of the stationary environment capture system 320 to the sensor interface 213 in the leading vehicle 200.

In further exemplary embodiments, the collection of data from the at least one stationary sensor 330 of the stationary environment capture system 320 and/or from at least one sensor 212 in the leading vehicle 200 and/or from at least one sensor 102 in the commercial vehicle 100 can be used to determine 332, 232, 132 a current position of the commercial vehicle 100 in the usable area 310, wherein the current position is determined at reference sign 332 by the stationary environment capture system, at reference sign 232 by the leading vehicle 200 and at reference sign 132 by the commercial vehicle 100 itself.

The commercial vehicle 100 can interchange data with the at least one data interface 214 of the leading vehicle 200 via its at least one data interface 104. The leading vehicle 200 may also interchange data with the sensor interface 313 of the stationary environment capture system 320 via its at least one sensor interface 213. The leading vehicle 200 may also act as forwarding or an “adapter” of data interchange between the stationary environment capture system 320 and the commercial vehicle 100.

For example, the current position (also: location) of the commercial vehicle 100 in a usable area 310 may be determined by means of at least one stationary sensor 330 and may be transmitted to the leading vehicle 200 via the sensor interfaces 313, 213 and from the leading vehicle to the commercial vehicle 100 via the data interfaces 214, 104. During transmission to the commercial vehicle 100, data from the determination 332 of the current position of the commercial vehicle by the stationary environment capture system 320 and from the determination 232 by the leading vehicle 200 may be combined.

In a first exemplary embodiment, the commercial vehicle 100 can determine a target trajectory by means of the determination unit 106 on the basis of the transmitted determination 332, 232 of the current position, optionally in combination with its own determination 132 of the current position and/or its own map data 140, and can control 109 specifications for controlled variables in the control unit 108.

In a second exemplary embodiment, the leading vehicle 200 comprises a determination unit 216 which determines a target trajectory or a future target position of the commercial vehicle 100 and transmits it to the commercial vehicle 100 via the respective data interfaces 214, 104.

In a third exemplary embodiment, the stationary environment capture system 320 comprises a determination unit 316 which determines a target trajectory or a future target position of the commercial vehicle 100 and transmits it to the leading vehicle 200 via the respective sensor interfaces 313, 213. The leading vehicle optionally determines at least one controlled variable at reference sign 219 and transmits this controlled variable to the commercial vehicle 100 via the respective data interfaces 214, 104 or forwards the data relating to a target trajectory or a future target position, which are generated by the stationary environment capture system 320, to the commercial vehicle 100 without change.

In a fourth exemplary embodiment, the stationary environment capture system determines controlled variables, for example a steering angle and/or acceleration specification, for the commercial vehicle 100 at reference sign 319 and transmits the associated data to the leading vehicle via the sensor interfaces 313, 213 and from the leading vehicle to the commercial vehicle 100 via the data interfaces 214, 104.

In each exemplary embodiment, the commercial vehicle 100 can use the data provided by the stationary environment capture system 320 and/or the leading vehicle 200 and transmitted via the leading vehicle 200 to carry out maneuvers.

The system is useful, for example, when driving a goods delivery vehicle capable of platooning, as a commercial vehicle 100, into a warehouse which is equipped with at least one stationary sensor 330 and has a usable area 310. In the usable area 310, a leading vehicle 200 operated by the warehouse can temporarily enter a platoon with the goods delivery vehicle (as a commercial vehicle) which therefore becomes the following vehicle 100. The following vehicle 100 can now follow the leading vehicle 200 into the vicinity of the parking position (also: destination stop). Upon arrival there, the platoon mode is terminated and the leading vehicle 200 supplies the following vehicle 100 at least with data from the at least one stationary sensor 330 of the warehouse, or the leading vehicle 200 even completely takes control of the following vehicle 100 in order to maneuver the latter to the destination stop.

The commercial vehicle 100 can be controlled from the leading vehicle 200 in various ways with the aid of the environmental sensors 102, 212, 330. In a first exemplary embodiment, the leading vehicle 200 transmits control instructions (also: control specifications) for the transverse and longitudinal guidance to the commercial vehicle 100 (for example steering wheel angle, steering angle, speed, acceleration). The control instructions can also be generated by a driver actuating the steering wheel and pedals in the leading vehicle 200. The leading vehicle 200 does not itself implement the control instructions, but rather remains at a standstill.

In a second exemplary embodiment, the leading vehicle 200 forwards sensor data relating to the environment to the commercial vehicle and allows the commercial vehicle 100 to process the sensor data. The leading vehicle 200 can intervene in critical situations using stop or abort signals.

In a third exemplary embodiment, the leading vehicle 200 drives forward and backward, wherein the commercial vehicle 100 keeps the distance to the leading vehicle 200 constant, like in the case of a trailer (“virtual towbar”). The leading vehicle 200 can ensure safe operation, in particular during reversing, and/or can accurately maneuver the commercial vehicle 100 by means of environmental sensors 212, 330 in the environment.

Although the present disclosure has been described with respect to exemplary embodiments, it is clear to a person skilled in the art that various changes can be made and equivalents can be used as a substitute. Furthermore, many modifications can be made in order to adapt a particular situation or a particular material to the teaching of the present disclosure. Consequently, the present disclosure is not restricted to the exemplary embodiments disclosed, but rather comprises all exemplary embodiments which fall within the scope of the accompanying patent claims.

### List of Reference Signs

100 Commercial vehicle
102 Sensor in the commercial vehicle
104 Data interface in the commercial vehicle
106 Determination unit in the commercial vehicle
108 Control unit in the commercial vehicle
109 Regulating unit of the control unit in the commercial vehicle
120 Front of the commercial vehicle
122 Rear of the commercial vehicle
132 Position of the commercial vehicle determined by the commercial vehicle
140 Stored data in the commercial vehicle
200 Leading vehicle
210 Apparatus
212 Sensor in the leading vehicle
213 Sensor interface in the leading vehicle
214 Data interface in the leading vehicle
216 Determination unit in the leading vehicle
219 Regulating unit of the control unit in the leading vehicle
232 Position of the commercial vehicle determined by the leading vehicle
240 Stored data in the leading vehicle
300 System
310 Usable area
313 Sensor interface of the stationary environment capture system
316 Determination unit of the stationary environment capture system
319 Regulating unit of the control unit of the stationary environment capture system
320 Stationary environment capture system
330 Stationary sensor
332 Position of the commercial vehicle determined by the stationary environment capture system
340 Stored data of the stationary environment capture system

1-15. (canceled)

16. A commercial vehicle for transversely and longitudinally guiding reversing of the commercial vehicle during controlled parking and/or maneuvering of the commercial vehicle as a following vehicle in accordance with a leading vehicle in an environment of the commercial vehicle, comprising:
at least one sensor and/or at least one data interface for capturing data relating to the environment of the commercial vehicle, wherein the captured environment comprises the commercial vehicle and/or the leading vehicle, and/or at least one data interface for capturing a control instruction for the transverse and longitudinal guidance from the leading vehicle in the environment of the commercial vehicle; and
a control unit which is designed to control the transverse and longitudinal guidance of the reversing of the commercial vehicle during controlled parking and/or maneuvering of the commercial vehicle on the basis of the captured data relating to the environment and/or the captured control instruction.

17. The commercial vehicle as claimed in claim 16, wherein the control unit comprises a determination unit which is designed to determine a target trajectory and/or a future target position of the commercial vehicle on the basis of the captured environment and/or control instruction, and wherein the control unit is also designed to control the transverse and longitudinal guidance of the reversing of the commercial vehicle on the basis of the determined target trajectory and/or future target position.

18. The commercial vehicle claimed in claim 17, wherein the determination unit also determines the target trajectory and/or the future target position on the basis of at least one predetermined distance between the commercial vehicle and the leading vehicle.

19. The commercial vehicle as claimed in claim 18, wherein the sensor and/or the data interface capture(s) at least two simultaneous distances between a front of the commercial vehicle and the leading vehicle and wherein the at least one predetermined distance comprises at least two simultaneous distances, and wherein the transverse and longitudinal guidance of the commercial vehicle determines a reversing curve of the commercial vehicle on the basis of a comparison of the at least two captured simultaneous distances and the at least two predetermined simultaneous distances.

20. The commercial vehicle as claimed in claim 18, wherein the sensor and/or the data interface capture(s) at least two simultaneous distances between a front of the commercial vehicle and a rear of the leading vehicle.

21. The commercial vehicle as claimed in claim 16, wherein the data relating to the environment which are received via the at least one data interface comprise data relating to the current position of the commercial vehicle and a future target position for parking the commercial vehicle.

22. The commercial vehicle as claimed in claim 16, wherein the control instruction received via the at least one data interface comprises a specification of at least one controlled variable of the transverse and longitudinal guidance by the leading vehicle, wherein the at least one controlled variable comprises a steering wheel angle and/or a steering angle and/or a speed and/or an acceleration.

23. The commercial vehicle as claimed in claim 16, wherein the commercial vehicle receives
data relating to the environment; and/or
a control instruction in response to a criterion being met from the leading vehicle via the data interface.

24. An apparatus for transversely and longitudinally guiding reversing of a commercial vehicle in an environment of a leading vehicle during controlled parking and/or maneuvering of the commercial vehicle as a following vehicle in accordance with the leading vehicle, wherein the apparatus is installed or can be installed in the leading vehicle, comprising:
at least one sensor and/or at least one sensor interface for capturing the environment of the leading vehicle, wherein the captured environment comprises the commercial vehicle and/or the leading vehicle; and
a data interface which is designed to transmit sensor data from the at least one sensor and/or from the at least one sensor interface and/or a control instruction determined on the basis of the sensor data to a data interface of the commercial vehicle.

25. The apparatus as claimed in claim 24, also comprising a determination unit which is designed to determine a target trajectory and/or a future target position of the commercial vehicle on the basis of the captured environment.

26. The apparatus as claimed in claim 25, wherein the determination unit also determines the target trajectory and/or the future target position of the commercial vehicle on the basis of at least one predetermined distance between the commercial vehicle and the leading vehicle.

27. The apparatus as claimed in claim 25, wherein the determination unit determines at least one controlled variable of the transverse and longitudinal guidance of the commercial vehicle, wherein the at least one controlled variable comprises a steering wheel angle and/or a steering angle and/or a speed and/or an acceleration.

28. The apparatus as claimed in claim 24, wherein the data relating to the captured environment which are transmitted via the data interface comprise data relating to the current position of the commercial vehicle and a future target position for parking the commercial vehicle.

29. A system for transversely and longitudinally guiding reversing of a commercial vehicle during controlled parking and/or maneuvering of the commercial vehicle, comprising:
a commercial vehicle as claimed in claim 16.

30. The system as claimed in claim 29, further comprising a leading vehicle having an apparatus as claimed in claim 24.

31. The system as claimed in claim 30, also comprising a usable area, wherein the usable area comprises at least one parking option for the controlled parking of the commercial vehicle.

32. The system as claimed in claim 31, wherein the at least one parking option is at a future target position for parking the commercial vehicle.

33. The system as claimed in claim 31, wherein the usable area comprises a stationary environment capture system (320) having
at least one sensor for capturing the usable area; and/or
stored map data relating to the usable area; and
a sensor interface which is designed to transmit data captured by the at least one sensor and/or the stored map data relating to the usable area to the sensor interface of the leading vehicle.
